(19) United States
(12) Patent Application Publication
(10) Pub. No.: US 2009/0284252 A1
(43) Pub. Date: Nov. 19, 2009

(54) Device for measuring the absolute position of at least two members that are movable or rotatable relative to each other

(75) Inventors: Christian Burgdorf, Offenbach (DE); Klaus Rink, Rodenbach (DE); Henrik Antoni, Frankfurt (DE); Veith Albrecht, Heusenstamm (DE); Frank Hickl, Gelshausen (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG

(21) Appl. No.: 11/664,470

(22) PCT Filed: Sep. 29, 2005
(86) PCT No.: PCT/EP05/54897

§ 371 Date: Jun. 18, 2009

(30) Foreign Application Priority Data
Sep. 30, 2004 (DE) 10 2004 048198.9
Sep. 29, 2005 (DE) 10 2005 046822.5

(51) Int. Cl. G01B 7/14

(52) U.S. Cl. 324/207.2; 324/207.21

(57) ABSTRACT

The objective is to provide a measuring device, which makes it possible to determine the absolute position (s) of a movable member comprising a permanent magnetic encoder (2) with a number of magnetic segments (4), the polarity of which alternates in the direction of measurement (r). To this end, a measuring device (1) includes two magnetic-field sensitive sensor elements (6) being spaced apart from each other, the length of the segments (4) of the encoder (2) being selected differently in the direction of measurement (r).

### BACKGROUND OF THE INVENTION

The present invention relates to a device for measuring the absolute position of at least two members that are movable or rotatable relative to each other.

Various possibilities for the non-contact measurement of positions and travels of two components that are movable relative to each other are known in technical science. The arrangements are generally composed of a signal transmitter or a scale mounted on one of the components, and a sensor or reading head scanning the pulse generator and being fitted on the other component. The scanning operation can be carried out e.g. using light signals or high-frequency signals, electric or magnetic fields. Among others, perforated discs, toothed wheels and magnetic structures are known as pulse generators.

For example, magnetically coded discs, rings or flat strips of magnetizable material, so-called encoders, render it possible to detect differences in travel by the use of magnetic field sensors. The variation of the magnetic field in terms of size or direction, induced by a relative displacement of the encoder and the sensor elements, allows conclusions as regards the direction and length of the movement.

It is principally desirable in designing such applications to be able to generate measured values that are reliable under signal technique aspects and reproducible, and to realize solutions as inexpensive as possible, on the other hand.

In motor vehicle technology, additional demands are placed on measuring systems of this type because the applications must be insensitive e.g. to the acceleration and vibrations of the motor vehicle and to high temperature variations and, in general, should exhibit a high rate of reliability and accuracy. In addition, there is mostly the necessity of maintaining the operability of measuring systems even when exposed to major contamination. Due to these requirements, magnetic-field-based sensors for measuring geometric quantities have proven especially favorable in motor vehicle technology. In particular, they can be used as sensors for measuring the wheel rotational speed, the throttle valve position, or the pedal travel.

WO 01/51893 discloses a concept allowing a linear travel sensor to sense a difference in travel and to emit it in the form of an electric output signal. In this publication, sensor elements that are axially offset in relation to each other and scan a rod-shaped encoder are described, which generate a phase-shifted signal.

DE 10020764 discloses an arrangement of a magnetic encoder, which is mounted on a piston rod of a vibration damper and (being protected by a layer against wear that is due to the friction of the piston rod relative to the guiding/sealing unit) moves in relation to a sensor element disposed close to the guiding/sealing unit to scan the applied magnetic coding.

However, this publication does not indicate how the sensor element at issue and the magnetization of the encoder must be designed under conditions that are relevant in practice, such as in the motor vehicle, in order to sense a position by means of only one sensor.

Only one graduation is necessary to measure movements in the concepts mentioned above. In particular, a magnetoresistive sensor can scan an encoder or a scale magnetized in strips to detect the displacement of the position of a brake pedal. However, it is disadvantageous in a measuring device of such a configuration that an absolute value of the position of the movable member can only be determined with considerable efforts, especially by using several encoders or like elements.

Compared thereto, EP 1 157 256 B1 discloses a system envisaged to allow measurement of an absolute position under certain, limiting conditions. A magnetized scale or encoder, which is magnetized like a screw, is provided in this system for this purpose so that the angle of the magnetization direction, depending on the location, increases constantly and continuously in square form with the space coordinate, when viewed in the longitudinal direction of the encoder. The manufacture of systems of this type is comparatively complicated especially as regards the material requirement, especially in view of the desired reliability and the precision in the adjustment of magnetization that is necessary for the accuracy of the measuring results. Further, an accurate guiding of the parts moved in relation to each other is required in the mentioned measuring assembly.

In view of the above, an object of the invention is to disclose a measuring device of the type described before, which allows reliably determining the absolute position of a movable member with a manufacturing effort that is kept especially low. Another objective relates to a method for determining the absolute position.

### SUMMARY OF THE INVENTION

This object is achieved with respect to the measuring device in that the position of a movable member is determined by way of at least two spaced magnetic-field sensitive sensor elements, wherein the movable member includes a permanent-magnetic encoder with a number of magnetic segments, the polarity of which alternates in the direction of measurement, and with the length of the segments differing in the direction of displacement.

The invention is based on the reflection that the determination of an absolute position can be achieved by means of a sensor assembly described hereinabove especially when a scale is arranged on the signal-emitting side of the information transmission, from which scale the position of the movable member on the signal-receiving side can be derived or generated, respectively. A definite allocation of position by way of the magnetized encoder can be achieved when its magnetization properties are chosen in an appropriate manner. However, in order to keep the manufacturing effort low, nevertheless, the requirements in terms of the magnetization to be applied into the scale should be maintained within limits so that in particular a design of the encoder in segments should be maintained.

In order to allow the desired conclusion to an absolute position likewise in this mode of construction, the magnetized segments of the encoder should differ from each other in their length in the direction of measurement so that the difference of angles between the directions of magnetic fields sensed by two spaced magnetic-field sensitive sensor elements depends definitely from the individual segments of the encoder and, thus, the position of the movable member can be derived. The difference in length of magnetized segments can be determined by the relation of phases, the difference of frequencies or the difference of amplitudes, and the determined length can be taken into account to identify the respective individual segment and, hence, to determine the absolute position by way of the segment's positioning in the encoder.

The generation of a signal value that is proportional to the position of the respective member is possible in a particularly simple fashion in that the length of the segments of the encoder in the direction of measurement increases favorably from segment to segment in such a fashion that the difference of angles sensed by the sensor elements which are spaced from each other, when viewed over the length of the encoder, increases proportionally with the length. The length from segment to segment can increase or decrease by a predefined constant amount especially with comparatively low position values.

In a like linear increase of the difference signal generated by way of the encoder, it is possible to obtain characteristic curves of the individual segments that are straight-lined in pieces, and to obtain from these in a particularly favorable manner an information proportional to the absolute position by using an appropriate mathematic operation of the electric sensor signals, especially by differentiation of the signal. The characteristic curves of individual elements exhibit a largely constant gradient up to the respective segment length λ/2.

In order that the determination of the position along the main moving direction of the movable member is independent of a movement about this main moving direction, the encoder is advantageously designed rotationally symmetrically, and rotationally symmetric magnetic fields are applied to its periphery. It is safeguarded hereby that the magnetic field of the encoder does not change in the event of movement of the encoder with the movable member about the main axis of movement of the encoder, which can be provided as the individual requirement may be. With a like configuration of the encoder, especially the reliable operability of the system is ensured, without having to consider the exact alignment or adjustment of the encoder during its installation.

For the purpose of achieving great reliability and resistance to environmental influences, the encoder preferably uses magnetic material that is embedded in plastics. The latter can be manufactured in a pressing operation or by injection-molding, and ferrite or neodymium iron boron (NdFeB) materials can be employed in particular. In the manufacture, the material is preferably magnetized in strips with a polarity that alternates in the direction of measurement.

For measuring the magnetic fields of the magnetized encoder, the respective sensor element preferably includes a number of sensors whose function is favorably based on the anisotropic magnetoresistive effect, the giant magnetoresistive effect, or the Hall effect. Magnetoresistive resistance layers can be applied in a meander-shaped fashion to a silicon carrier to achieve a high resolution.

An output signal that is proportional to the position of the movable member is preferably calculated for a simple and exact determination of the absolute position of the movable member by way of a number of sensor element signals. To this end, the measuring device favorably has an evaluation unit used to execute the calculation. Favorably, amplitude signals, frequency signals or phase signals are evaluated as sensor element signals.

In order to generate a signal that is proportional to the position of the movable member, a number of meter bridges of a sensor element are suitably arranged at an angle of 45° in relation to each other. When two Wheatstone meter bridges are used, which are turned by 45° relative to each other and are arranged at the same position with respect to the movable member or the encoder, respectively, it is possible to generate a corresponding sinusoidal and cosine electric output signal by use thereof.

A combination of these signals renders it possible to calculate an output signal that is proportional to the position of the movable member, advantageously using an arc tangent function for this purpose.

Favorably, sensor elements are used for calculating the output signal, which generate segment by segment an angle signal that rises linearly in pieces over the length of the respective segment. This can e.g. be achieved by using sensor elements of the mentioned type, where transducers turned by 45° relative to each other are employed. These transducers generate a signal that is proportional to the sine of the field vector angle, on the one hand, and a signal that is proportional to the cosine of the field vector angle, on the other hand. Thus, the desired angle signal, which rises linearly in pieces over the length of the respective segment, can be produced from the relation of these signals and a subsequent application of the arc tangent function.

Due to the length of the individual segments monotonously increasing or decreasing along the longitudinal direction of the encoder, it is safeguarded that the difference between the angle signals generated by two spaced sensor elements of the mentioned type correlates without doubt with the positioning of the sensor elements relative to the encoder. Advantageously, the position to be determined is therefore found out by means of the difference between the angle signals generated by two sensor elements.

The mentioned difference can be taken into account directly for determining the position in the type of a measurement of the absolute position. Alternatively, in a favorable improvement, the position can be determined, however, also in the way of a two-stage configuration, where initially in a first step the segment that is currently sensed by the sensor elements is determined in the type of a rough determination, while in a second step the positioning of the respective sensor element with regard to the identified segment takes place in a type of a precision measurement. To this end, the difference between the angle signals is suitably used to identify the respective segment in a first step of evaluation, while in a second step of evaluation the angle signal of one of the sensor elements is used to determine the position in relation to the respective segment.

Advantageously, the concept of using an encoder with differently long magnetized segments in the direction of displacement is applied in a motor vehicle sensor in particular as:
Pedal travel sensor
Accumulator travel sensor in hydraulic or pneumatic accumulators
Shock absorber level sensor
Booster travel sensor for measuring the position of the brake booster
Brake lining wear indicator
Filling level determining device in fluid tanks
Position sensor in the sliding roof
Position sensor in the convertible top
Position sensor for window lifters
Headlamp position
Determination of the seat position
Steering angle sensor
Sensor for determining the crankshaft position
Throttle valve sensor
Sensor for determining the valve position in the engine.

The advantages of the invention especially reside in that the measuring device described allows a non-contact measurement of an absolute position. The measured value obtained is directly at disposal again also after the electronic unit is disabled and subsequently re-enabled, without there being the need for an external starting value or for intermediate storage. Another advantage resides in that calibration of the measuring device is not required and components of the measuring device can be replaced when worn out without a new calibration. The measuring device is especially well suited for the application in a motor vehicle under marginal conditions relevant for this purpose such as corrosion, contamination, extreme temperature variations at a high rate of precision and resolution.

Further, the invention renders it possible to calculate additional measured quantities such as the rate of motion, the acceleration, and the moving direction.

Besides, the measuring device described exhibits a very high rate of resolution and precision. Quantization of the individual sensor signals further allows realizing an increment detection, where based on an absolute position once identified, the displacements that subsequently occur are determined or monitored in the way of a tracking operation.

### BRIEF DESCRIPTION OF THE DRAWINGS

One embodiment of the invention is explained in more detail by way of the accompanying drawings:

FIG. 1 schematically represents a measuring device for determining the position of a movable member;

FIG. 2 schematically represents the variation of a magnetic field of an encoder and the sensor assembly of the measuring device according to FIG. 1, and

FIG. 3 shows the course of the sensor element signals and the output signal A of the measuring device according to FIG. 1.

### DETAILED DESCRIPTION OF THE DRAWINGS

Like parts have been assigned like reference numerals in all Figures.

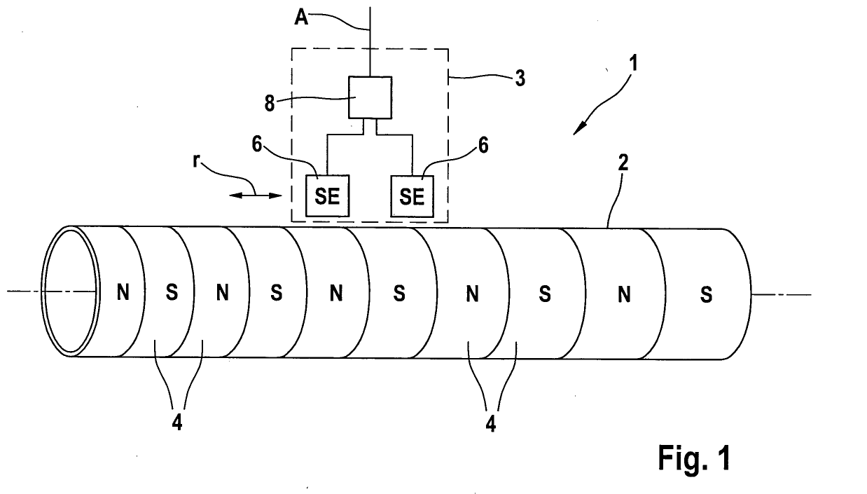

FIG. 1 schematically shows a measuring device 1 for determining the position of a movable member. The member is not defined in the embodiment. Many possible applications are feasible such as the measurement of a pedal travel, an accumulator travel in hydraulic or pneumatic accumulators, a shock absorber, a booster travel, brake lining thickness, a filling level in fluid tanks, the position of a sliding roof or a convertible top, the measurement for determining a throttle valve position, or other possibilities. Possible applications are not limited to the field of motor vehicles, but are especially well suited therefor. In principle, the measuring device 1 can measure the absolute position s of all members in a non-contact manner, which members can be moved or displaced along a distance or an arc.

For encoding of the position s of a movable member of this type, the latter is provided with a magnetic encoder 2 that is illustrated schematically in FIG. 1. Encoder 2 is rigidly coupled to the movable member and is moving with it. In the embodiment, encoder 2 is designed as injection-molded plastic-bonded neodymium iron boron and includes permanent-magnetic segments 4 of an alternating polarity in the direction of measurement of the member. In order to measure the absolute position s of the movable member by way of the magnetic field of the segments 4 of the encoder 2, the segments 4 have an increasing length in the direction of measurement r. The increase in length is chosen such that the difference of angles sensed by the sensor elements, which are spaced from one another, increases over the length of the encoder proportionally with said.

The encoder 2 is rotationally symmetric in the embodiment so that a rotation about this longitudinal axis, which extends in the direction of measurement r, does not influence the magnetic field.

To measure the magnetic field of the segments 4, two sensor elements 6 are arranged at the encoder 2, which are used to calculate by way of an evaluation unit 8 an electric output signal A that is proportional to the position s of the encoder 2 and, thus, of the member. The sensor elements 6 are positioned at a constant distance aₛ relative to each other and in non-contact manner relative to the encoder 2. A magnetization, which is constant for each segment 4 and alternates between adjacent segments 4, is applied to the encoder 2 in segments. The magnetic field generated by this magnetization produces a rising difference angle that can be sensed by the sensor elements 6 depending on the position, with the sensor distance being invariable.

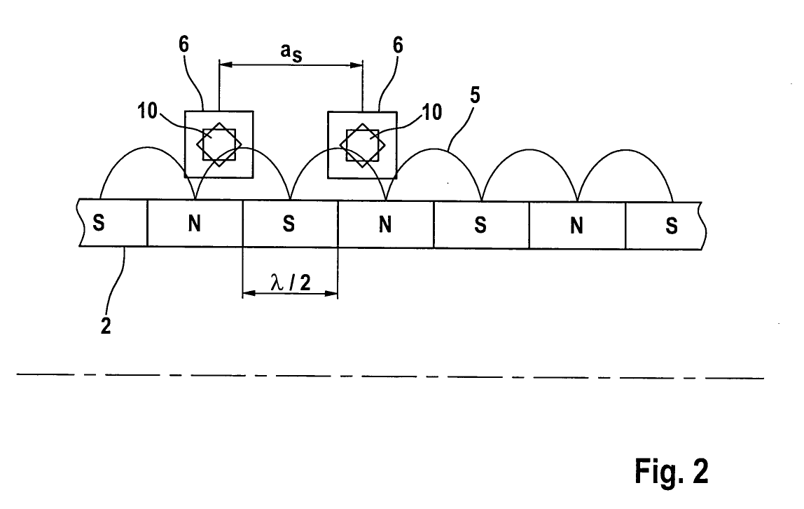

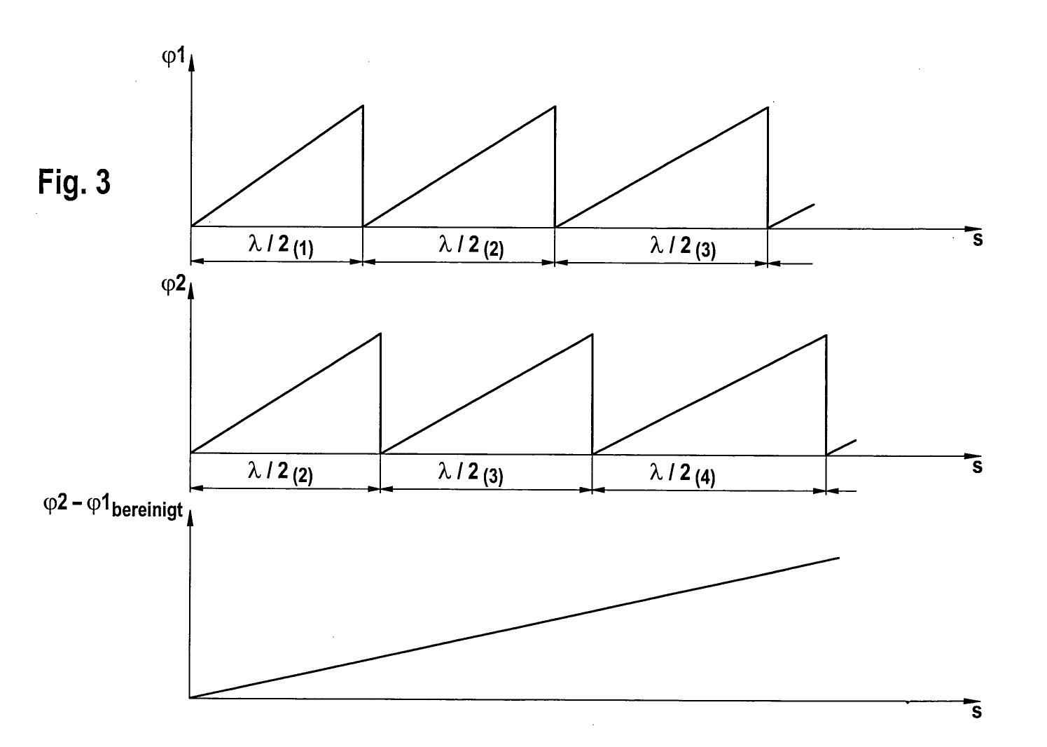

As is illustrated schematically in FIG. 2, the two sensor elements 6 include in each case two Wheatstone meter bridges 10, which are arranged on top of each other and are turned by 45° relative to each other. An anisotropic magnetoresistive resistor (AMR) is connected as a sensor in each Wheatstone meter bridge 10. Due to the 45° turn, the two Wheatstone meter bridges 10 of a sensor element 6 generate in each case one sinusoidal and one cosine output signal when the encoder 2 displaces. With these two signals, the control unit 8 produces for each sensor element 6 with an arc tangent function a characteristic curve φ1 und φ2 that is straight-lined within a pole length, as illustrated in FIG. 3. An output signal A that is proportional to the position s of the movable member is calculated from a comparison of these characteristic curves φ1 and φ2 by way of differentiation. The jumps of the functions that occur in the change-over of segments, i.e. with pole lengths of respectively λ/2, can be used as an index mark so that the difference of φ2-φ1 can be rid of the jumps by a corresponding interpolation.

The resulting output signal A=(φ2−φ1)_{rid} is also shown in FIG. 3. This corresponds to the absolute position.

Alternatively, the sensed difference of angles can also be used to identify in a first step of evaluation the respectively active segment 4, thereby providing a rough determination of the position s. The subsequent precision determination of the position s may then take place based on the characteristic curve of one of the sensor elements 6.

The illustrated principle of measurement does not require a strictly monotonous space characteristic curve and, especially in selected partial ranges of the encoder, can be particularly emphasized in the way of a selective focusing, in that the provided segmentation is chosen with a position-responsively increasing segment length preferably in these partial ranges.

### LIST OF REFERENCE NUMERALS

1 measuring device
2 encoder
4 segment
6 sensor element
8 evaluation unit
10 Wheatstone meter bridge
r direction of measurement
s position
aₛ distance
A output signal

1-11. (canceled)

12. A measuring device (1) for measuring absolute positions of at least two members that are movable relative to each other, the device comprising:
a first member having a permanent-magnetic encoder (2) with a number of magnetic segments (4) of an alternating polarity in a direction of measurement (r); and
a second member includes at least two magnetic-field sensitive sensor elements (6) which are spaced from each other, with the length of the segments (4) being different in the direction of measurement (r).

13. A device according to claim 12, wherein the length of the segments (4) of the encoder (2) increases or decreases monotonously or strictly monotonously in the direction of measurement (r) from segment (4) to segment (4).

14. A device according to claim 12, wherein the encoder (2) has a rotationally symmetric design.

15. A device according to claim 12, wherein the encoder (2) is provided with magnetic material embedded in plastics.

16. A device according to claim 12, wherein at least one sensor element (6) includes a number of sensors whose functions are based on the anisotropic magnetoresistive effect, the giant magnetoresistive effect, or the Hall effect.

17. A device according to claim 12, wherein a number of meter bridges of a sensor element (6) are arranged at an angle of 45° relative to each other.

18. A method of determining positions of a movable member by using a measuring device (1) having a first member having a permanent-magnetic encoder (2) with a number of magnetic segments (4) of an alternating polarity in a direction of measurement (r) and a second member having at least two magnetic-field sensitive sensor elements (6) which are spaced from each other, with the length of the segments (4) being different in the direction of measurement (r) the method comprising:
calculating a number of sensor element signals an output signal (A) that is proportional to a position of the movable member.

19. A method according to claim 18, wherein amplitude signals, frequency signals or phase signals are evaluated as sensor element signals.

20. A method according to claim 18, wherein an angle signal that is rising linearly in pieces is generated by each sensor element (6) in each case in segments over the length of the respective segment (4).

21. A method according to claim 20, the position is determined by the difference between the angle signals generated by two sensor elements (6).

22. A method according to claim 18, the difference of the angle signals is used to identify the respective segment (4) in a first step of evaluation, while in a second step of evaluation the angle signal of one of the sensor elements (6) is used to determine the position (s) in relation to the respective segment (4).
